(19) United States
(12) Patent Application Publication
(10) Pub. No.: US 2013/0223653 A1
(43) Pub. Date: Aug. 29, 2013

(54) Wireless Microphone System With Frequency Matching Capability, And Method For Frequency Matching In A Wireless Microphone System

(71) Applicant: TAIWAN CAROL ELECTRONICS CO., LTD., (US)

(72) Inventor: Chao-Chih Chang, Taichung City (TW)

(73) Assignee: TAIWAN CAROL ELECTRONICS CO., LTD., Taichung City (TW)

(21) Appl. No.: 13/705,052

(22) Filed: Dec. 4, 2012

(30) Foreign Application Priority Data
Feb. 23, 2012 (TW) 101106008

(51) Int. Cl. H04R 3/00

(52) U.S. Cl. CPC H04R 3/00
USPC 381/122

(57) ABSTRACT

A wireless microphone system includes a receiver device, a wireless microphone device, a transmitting unit operable to transmit an identification code and a frequency matching signal, and a reading unit. The reading unit is operable to receive the identification code and the frequency matching signal, determine whether or not the identification code corresponds to the reading unit, and enable frequency matching between the receiver device and the wireless microphone device according to the frequency matching signal when the identification code is determined to correspond to the reading unit.

### BACKGROUND OF THE INVENTION

1. Field of the Invention

The invention relates to a microphone system, and more particularly to a wireless microphone system with frequency matching capability and a method for frequency matching in the wireless microphone system.

2. Description of the Related Art

Presently, wireless microphones are commonly used in many situations, such as classrooms, KTV rooms, meeting rooms, etc. To prevent interference from other wireless microphone systems nearby, different frequencies are set in the microphone systems at different areas. After completion of frequency matching between a microphone and a corresponding receiver, signal interference may be avoided.

In U.S. Pat. No. 6,671,498, a conventional method for frequency matching in a wireless microphone system is disclosed, wherein frequency matching is performed by pressing a button on the receiver to allow the receiver to transmit a frequency matching signal to the wireless microphone through infrared light.

However, preset frequencies of the frequency matching may vary among different manufacturers. When a user is unaware that the microphone and the receiver are of different brands or models and performs frequency matching, the microphone may malfunction, or the frequency matching may not be successful.

### SUMMARY OF THE INVENTION

Therefore, an object of the present invention is to provide a wireless microphone system with frequency matching capability and a method for frequency matching therein that may prevent users from using non-matching wireless microphone device and receiver device.

According to one aspect of the present invention, a wireless microphone system comprises:

a receiver device;

a wireless microphone device;

a transmitting unit disposed in one of the receiver device and the wireless microphone device, and operable to transmit an identification code and a frequency matching signal; and

a reading unit disposed in the other one of the receiver device and the wireless microphone device, and operable to

receive the identification code and the frequency matching signal transmitted by the transmitting unit,

determine whether or not the identification code corresponds to the reading unit, and

enable the other one of the receiver device and the wireless microphone device to perform frequency matching with the one of the receiver device and the wireless microphone device according to the frequency matching signal when the identification code is determined to correspond to the reading unit.

According to another aspect of the present invention, a method for for frequency matching in a wireless microphone system including the aforesaid elements comprises:

a) transmitting an identification code and a frequency matching signal using the transmitting unit;

b) receiving the identification code and the frequency matching signal transmitted by the transmitting unit using the reading unit;

c) determining, using the reading unit, whether or not the identification code corresponds to the reading unit; and

d) enabling the other one of the receiver device and the wireless microphone device to perform frequency matching with said one of the receiver device and the wireless microphone device according to the frequency matching signal when the identification code is determined to correspond to the reading unit.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram showing a preferred embodiment of the wireless microphone system according to the present invention;

FIG. 2 is a block diagram of the preferred embodiment; and

FIG. 3 is a flow chart illustrating steps of the method for frequency matching using the preferred embodiment.

### DETAILED DESCRIPTION OF THE PREFERRED EMBODIMENT

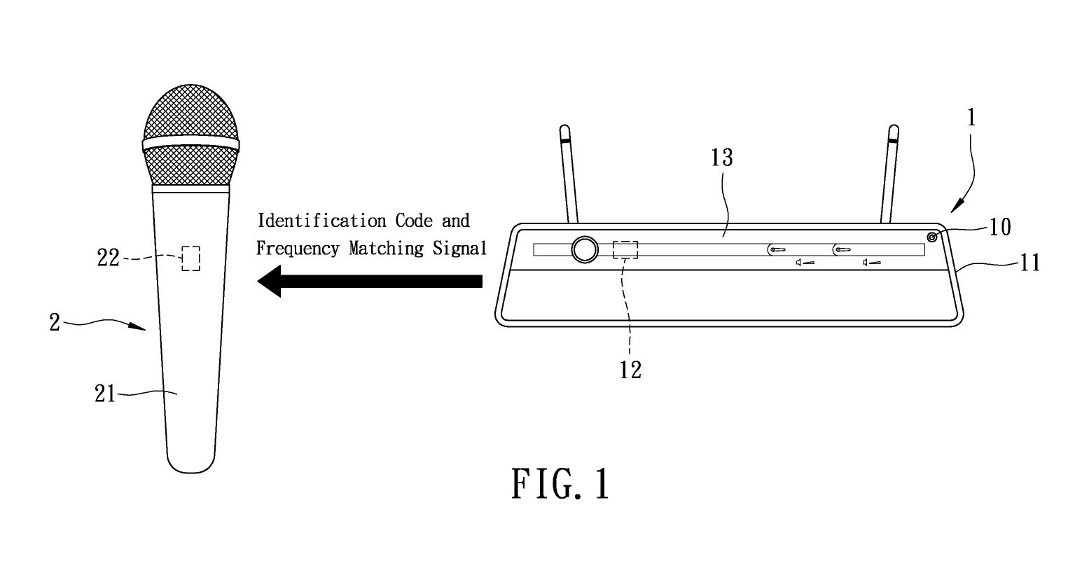

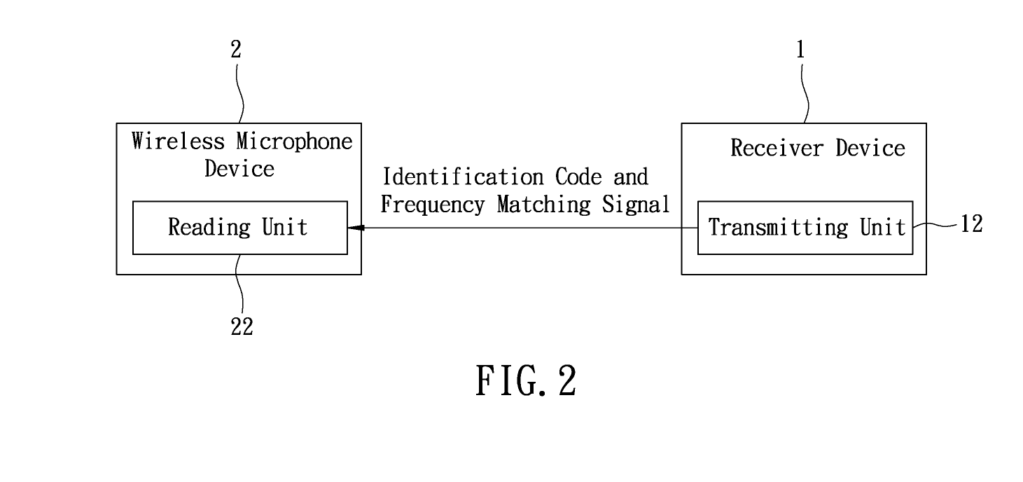

Referring to FIG. 1 and FIG. 2, the preferred embodiment of the wireless microphone system according to this invention is shown to include a receiver device 1, a wireless microphone device 2, a transmitting unit 12 disposed in one of the receiver device 1 and the wireless microphone device 2, and a reading unit 22 disposed in the other one of the receiver device 1 and the wireless microphone device 2. In this preferred embodiment, the transmitting unit 12 is disposed in the receiver device 1, and the reading unit 22 is disposed in the wireless microphone device 2. That is, in other embodiments, the transmitting unit 12 may be disposed in the wireless microphone device 2, and the reading unit 22 may be disposed in the receiver device 1.

The receiver device 1 includes a housing 11, and a panel 13 disposed at a front side of the housing 11. The transmitting unit 12 is disposed in the housing 11.

In this preferred embodiment, the panel 13 is made from a non-electromagnetic shielding material, such as acrylonitrile butadiene styrene (ABS).

In this preferred embodiment, the transmitting unit 12 is operable to transmit an identification code and a control signal set using radio frequency identification (RFID) technology. The control signal set includes a frequency matching signal, and other control signals depending on functions of the wireless microphone system, such as a volume control signal, etc.. In application, transmission of the identification code and the frequency matching signal maybe conducted once or continuously for a predetermined time period (such as ten seconds) according to a trigger of a switch 10 of the receiver device 1.

The identification code may include information for identifying the manufacturer of the system. In other embodiments, the identification code and the frequency matching signal may be transmitted using bluetooth, infrared, microwave, wireless network, etc..

The wireless microphone device 2 includes a microphone shell 21, and the reading unit 22 is disposed in the microphone shell 21. The reading unit 22 is operable to receive the identification code and the frequency matching signal. In this preferred embodiment, the reading unit 22 is configured to receive the identification code and the frequency matching signal transmitted by the transmitting unit 12 using RFID technology.

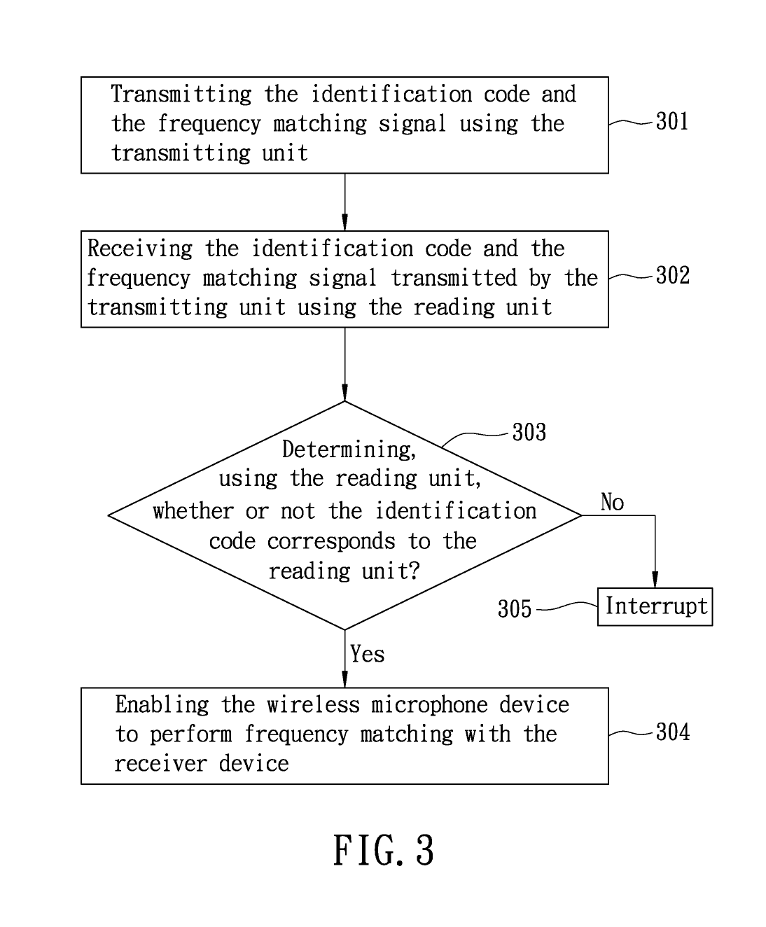

A method for frequency matching in the preferred embodiment of the wireless microphone system is executed after the switch 10 of the receiver device 1 is triggered, and includes the following steps as shown in FIG. 3.

Step 301: transmitting the identification code and the frequency matching signal using the transmitting unit 12.

Step 302: receiving the identification code and the frequency matching signal transmitted by the transmitting unit 12 using the reading unit 22.

Preferably, the reading unit 22 is operable to receive the identification code and the frequency matching signal within a 1 meter range from the transmitting unit 12. If the reading unit 22 is too far from the transmitting unit 12 to receive the identification code and the frequency matching signal, the switch 10 needs to be re-triggered to repeat step 301.

Step 303: determining, using the reading unit 22, whether or not the identification code corresponds to the reading unit 22.

Step 304: enabling the wireless microphone device 2 to perform frequency matching with the receiver device 1 according to the frequency matching signal when the identification code is determined to correspond to the reading unit 22. In detail, the reading unit 22 is configured to change a microphone parameter of the wireless microphone device 2 according to the frequency matching signal to perform frequency matching with the receiver device 1 when the identification code is determined to correspond to the reading unit 22. In this preferred embodiment, the microphone parameter is a microphone frequency.

Step 305: interrupting the entire process when the identification code is determined to not correspond to the reading unit 22.

To sum up, the present invention may prevent users from using non-matching wireless microphone device and receiver device by confirmation of the identification code, so as to facilitate frequency matching operation using the matched wireless microphone device and receiver device.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A wireless microphone system comprising:
a receiver device;
a wireless microphone device;
a transmitting unit disposed in one of said receiver device and said wireless microphone device, and operable to transmit an identification code and a frequency matching signal; and
a reading unit disposed in the other one of said receiver device and said wireless microphone device, and operable to
receive the identification code and the frequency matching signal transmitted by said transmitting unit,
determine whether or not the identification code corresponds to said reading unit, and
enable the other one of said receiver device and said wireless microphone device to perform frequency matching with said one of said receiver device and said wireless microphone device according to the frequency matching signal when the identification code is determined to correspond to said reading unit.

2. The wireless microphone system as claimed in claim 1, wherein said transmitting unit is disposed in said receiver device, and said reading unit is disposed in said wireless microphone device.

3. The wireless microphone system as claimed in claim 2, wherein said reading unit is configured to change a microphone frequency of said wireless microphone device according to the frequency matching signal to perform frequency matching with said receiver device when the identification code is determined to correspond to said reading unit.

4. The wireless microphone system as claimed in claim 1, wherein said transmitting unit and said reading unit are configured to communicate with each other using radio frequency identification (RFID) technology.

5. A method for frequency matching in a wireless microphone system, the wireless microphone system including a wireless microphone device, a receiver device, a transmitting unit disposed in one of the wireless microphone device and the receiver device, and a reading unit disposed in the other one of the wireless microphone device and the receiver device, said method comprising the steps of:
a) transmitting an identification code and a frequency matching signal using the transmitting unit;
b) receiving the identification code and the frequency matching signal transmitted by the transmitting unit using the reading unit;
c) determining, using the reading unit, whether or not the identification code corresponds to the reading unit; and
d) enabling the other one of the receiver device and the wireless microphone device to perform frequency matching with said one of the receiver device and the wireless microphone device according to the frequency matching signal when the identification code is determined to correspond to the reading unit.

6. The method as claimed in claim 5, the transmitting unit being disposed in the receiver device, the reading unit being disposed in the wireless microphone device, wherein step d) includes:
configuring the reading unit to change a microphone frequency of the wireless microphone device according to the frequency matching signal to perform frequency matching with the receiver device when the identification code is determined to correspond to the reading unit.

7. The method as claimed in claim 5, wherein:
in step a), the transmitting unit is configured to transmit the identification code and the frequency matching signal using radio frequency identification (RFID) technology; and
in step b), the reading unit is configured to receive the identification code and the frequency matching signal transmitted by the transmitting unit using RFID technology.
